(19) United States
(12) Patent Application Publication
(10) Pub. No.: US 2008/0170019 A1
(43) Pub. Date: Jul. 17, 2008

(54) Liquid Crystal Display Device Capable of Lowering Electric Power Consumption without Generating Flicker

(76) Inventor: Hirofumi KATO, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/955,857

(22) Filed: Dec. 13, 2007

(30) Foreign Application Priority Data
Jan. 12, 2007 (JP) 2007-4963

(51) Int. Cl. G09G 3/36

(52) U.S. Cl. 345/89; 345/102

(57) ABSTRACT

In the liquid crystal display device, in case a value prepared for setting brightness to a pixel is “001110”(L14), 8 bits obtained by the bit-shifting to lower direction by 2 bits(2 bit-shifting) and the setting of the bit value “1” is “11001110”. Frame rate control is thereafter performed by using upper 6 bits “110011” and 6 bits “110010” obtained when 1 is reduced from “110011”.

### CROSS-REFERENCE TO RELATED APPLICATIONS

This application is based upon and claims the benefit of priority from Japanese Patent Application No. 2007-004963 filed on Jan. 12, 2007;

the entire contents of which are incorporated herein by reference.

### BACKGROUND OF THE INVENTION

1. Field of the Invention

The present invention relates to a liquid crystal display device capable of lowering electric power consumption without generating flicker.

2. Description of the Related Art

Since there are many chances of driving a notebook type personal computer (PC) by a battery, lowering electric power consumption is required in terms of a liquid crystal display device used in the PC. Therefore, for example, when a mode of lowering electric power consumption is set, a method of lowering driving frequency is performed.

In the method of lowering driving frequency, horizontal cycle and vertical cycle do not lower but clock frequency lowers. Therefore, refresh rate of liquid crystal lowers and flicker might happen due to leak of electric charge from pixels.

It is an object of the present invention to provide a liquid crystal display device capable of lowering electric power consumption without generating flicker.

### SUMMARY OF THE INVENTION

A liquid crystal display device according to the first aspect of the present invention having pixels each consuming minimum electric power if a bit value “k”(k:1 or 0) is set to each bit of n(n: integer equal to or more than 2) bits used for setting brightness to the pixel is characterized by including: a gradation shift circuit configured to bit-shift the n bits to lower direction by m(m: integer) bit(s) and thereafter set the bit value “k” to each bit of upper m bit(s) of the bits obtained when the bit-shifting is done, and a circuit configured to make the brightness corresponds to upper n bit(s) of the bits obtained when the setting of the bit value “k” is done.

In the first aspect of the present invention, since each of the upper m bit(s) set by the bit value “k” is invariable, electric power consumed by the pixel lowers. Thus, electric power consumption lowers, flicker due to lowering driving frequency not happening.

A liquid crystal display device according to the first aspect of the present invention having pixels each consuming minimum electric power if a bit value “k”(k:1 or 0) is set to each bit of n(n: integer equal to or more than 2) bits used for setting brightness to the pixel is characterized by including: a gradation shift circuit configured to bit-shift the n bits to lower direction by m(m: integer) bit(s) and thereafter set the bit value “k” to each of upper m bit(s) of the bits obtained when the bit-shifting is done, and a frame rate control circuit configured to add or reduce 1 to or from upper n bits of the bits obtained when the setting of the bit value “k” is done and thereafter make a rate correspond to lower m bit(s) of the bits obtained when the setting of the bit value “k” is done, the rate being a rate of a number of frame(s) when the brightness corresponds to upper n bits of the bits obtained when the addition or the reduction is done and a number of frame(s) when the brightness corresponds to upper n bits of the bits obtained when the setting of the bit value “k” is done.

In the second aspect of the present invention, as well as in the first aspect, since each of the upper m bit(s) set by the bit value “k” is invariable, electric power consumption lowers, flicker due to lowering driving frequency not happening.

In addition, since each of the upper m bit(s) is invariable, a number of grades the pixel can present in one frame lowers, but a number of grades the pixel can present in the total frames can be more than the number of grades in one frame.

A liquid crystal display device according to the third aspect of the present invention is characterized by further including a backlight facing a back side of the pixels, and a backlight control circuit configured to lower brightness of the backlight in case the bit-shifting and the setting of the bit value “k” are done to prevent the pixel from being brighter.

The third aspect of the present invention is a liquid crystal display device of “normally white”. In the liquid crystal display device, since the brightness of the backlight is lowered in case the bit-shifting and the setting of the bit value “k” are done, electric power consumption in the backlight lowers. It contributes to lowering electric power consumption in the device together with lowering electric power consumption in the pixels.

### BRIEF DESCRIPTION OF THE DRAWINGS

FIG. 1 illustrates a block diagram of a liquid crystal display device according to an embodiment of the present invention and a control device used with the liquid crystal display device;

FIG. 2 illustrates a block diagram of a timing controller in the liquid crystal display device;

FIG. 3 illustrates a block diagram of a signal line driving circuit in the liquid crystal display device;

FIG. 4 illustrates a circuit diagram of a gradation circuit and a part of a digital-analog conversion circuit in the liquid crystal display device;

FIG. 5 illustrates a method of setting brightness to a pixel in case 2 bit-shifting is done;

FIG. 6 illustrates a method of setting brightness to a pixel in case that 1 bit-shifting is done;

FIG. 7 illustrates relation between original values for setting brightness to a pixel and a method of setting brightness to a pixel using the value;

FIG. 8 illustrates a method of setting same brightness corresponding to an intermediate grade to each of pixels;

### DESCRIPTION OF THE EMBODIMENT

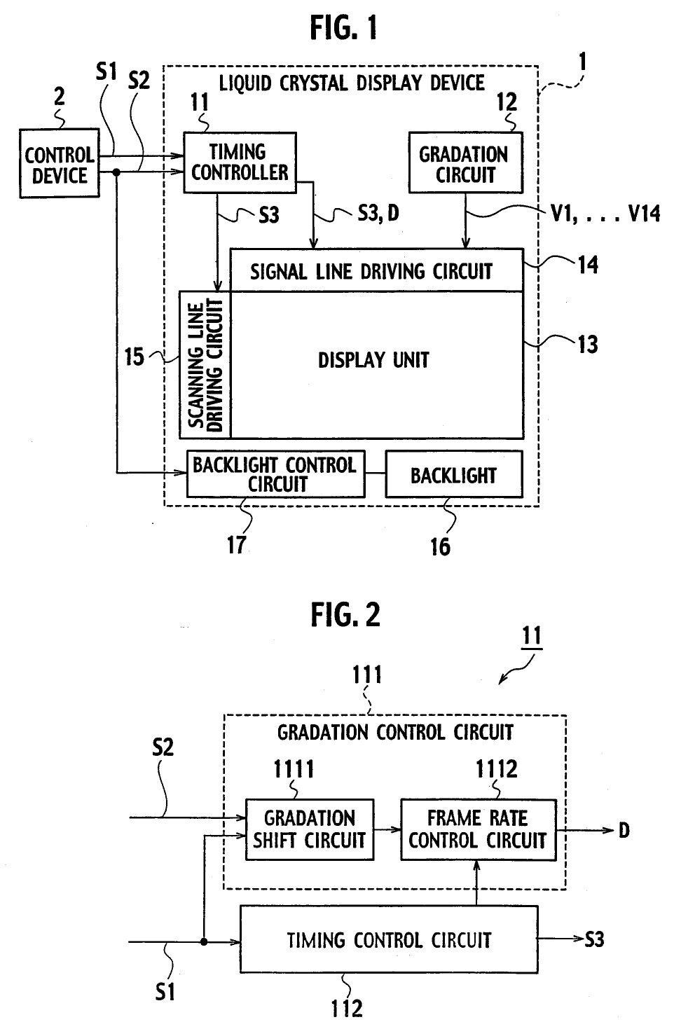

FIG. 1 illustrates the liquid crystal display device 1 according to the embodiment used in a notebook type personal computer (PC) and the control device 2 for example. The liquid crystal display device 1 has the timing controller 11 to which signals are inputted from the control device 2, the gradation circuit 12 which generates gradation base voltages, a display unit 13 having pixels configured with liquid crystal the signal line driving circuit 14 which drives signal lines formed in the display unit 13, a scanning line driving circuit 15 which drives scanning lines formed in the display unit 13, a backlight 16 facing back side of the display unit 13, a backlight control circuit 17 which controls brightness of the backlight 16. Note that the liquid crystal display device 1 is assumed to be a “normally white” device.

Although not illustrated, the display unit 13 has an array substrate, an opposing substrate and a liquid crystal layer formed between the array substrate and the opposing substrate. In the array substrate, the signal lines and the scanning lines are disposed so as to cross each other, and a pixel transistor is connected to the signal line and the scanning line at each intersection, and a pixel electrode is connected to the pixel transistor. In the opposing substrate, red color filters, green color filters and blue color filters are disposed regularly, one color filter being for one pixel electrode. In the opposing substrate, an opposing electrode is formed, opposing all of the pixel electrodes. Each part of the display unit 13 occupied by each pixel electrode and the likes is called a pixel.

The control device 2 is configured to provide an image display signal S1 and a power save signal S2 to the timing controller 11. The image display signal S1 has synchronizing signals and an image data that consists of values each consists of 6 bits, each value being prepared for setting brightness to a corresponding pixel. The power save signal S2's level becomes high in case lowering electric power consumption is necessary.

The timing controller 11 is configured to provide a drive control signal S3 for controlling the signal line driving circuit 14 and the scanning line driving circuit 15 to the signal line driving circuit 14 and the scanning line driving circuit 15. The timing controller 11 is configured to provide an image data D to the signal line driving circuit 14. The image data D is the image data in the image display signal S1 or an image data that consists of values with which the values of the image data in the image display signal S1 are replaced.

The gradation circuit 12 is configured to generate gradation base voltages V1, . . . V14 each becoming a base for setting a grade of brightness to the each pixel.

As illustrated in FIG. 2, the timing controller 11 has a gradation control circuit 111 and a timing control circuit 112. The gradation control circuit 111 creates the image data D that consists of values with which the values of the image data in the image display signal S1 are replaced in case the power save signal S2's level is high. The timing control circuit 112 creates the drive control signal S3 based on the image display signal S1.

The gradation control circuit 111 has a gradation shift circuit 1111 and a frame rate control circuit 1112. The gradation shift circuit 1111 bit-shifts each value of the image data in the image display signal S1 to lower direction by 2 bits and thereafter sets a bit value “k”(k:1 or 0) to each bit of upper m bit(s) of the bits obtained when the bit-shifting is done. The frame rate control circuit 1112 compensates decrease in a number of grades the pixel can present due to the bit-shifting and the setting of the bit value “k” by realizing psuedo gradation.

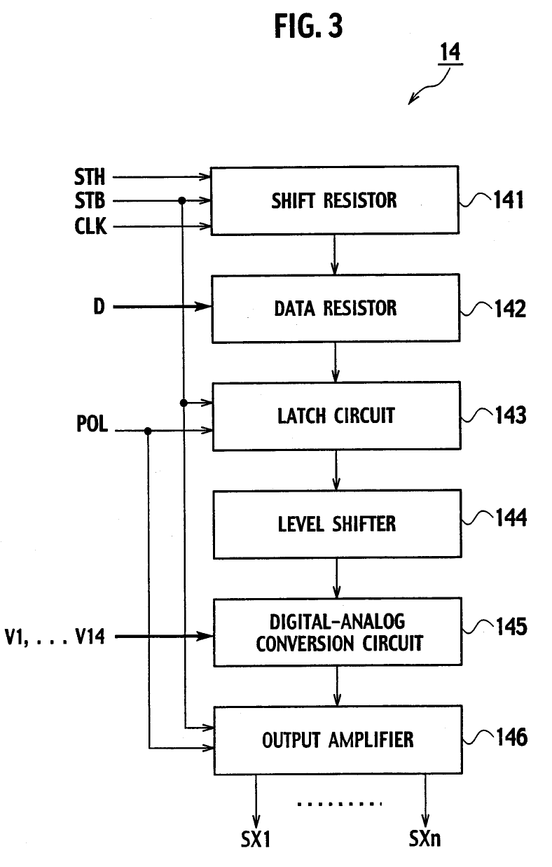

As illustrated in FIG. 3, the signal line driving circuit 14 has a shift resistor 141, a data resistor 142, a latch circuit 143, a level shifter 144, a digital-analog conversion circuit 145 and an output amplifier 146. The shift resistor 141 takes the image data D and generates shift pulse. The data resistor 142 takes the image data D by the shift pulse. The latch circuit 143 reads the image data D from the data resistor 142. The level shifter 144 raises amplitude of signals of the image data D. The digital-analog conversion circuit 145 converts the image data D in which amplitude of signals are raised to analog signals. The output amplifier 146 amplifies the analog signals.

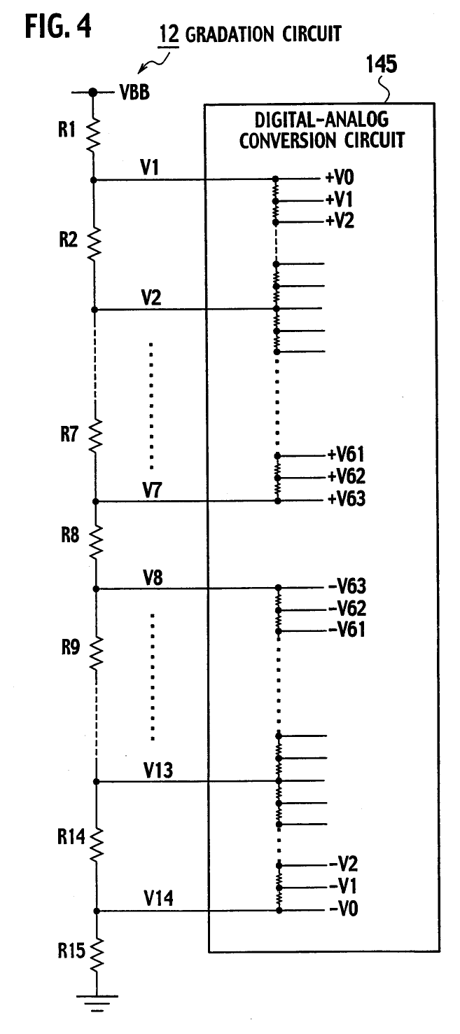

As illustrated in FIG. 4, the gradation circuit 12 divides a voltage VBB by resistors R1, . . . R15 to create the gradation base voltages V1, . . . V14.

The digital-analog conversion circuit 145 generates voltages +V0, . . . +V63 being used in case a voltage of a pixel electrode should be higher than the voltage of the opposing electrode and voltages −V0, . . . −V63 being used in case a voltage of a pixel electrode should be lower than the voltage of the opposing electrode. To make a voltage of a pixel electrode be higher than the voltage of the opposing electrode is called to make polarity of a pixel electrode be positive. To make a voltage of a pixel electrode be lower than the voltage of the opposing electrode is called to make polarity of a pixel electrode be negative.

[Operations of the Liquid Crystal Display Device 1]

Next, operations of the liquid crystal display device 1 will be described.

Firstly, an operation in case lowering electric power consumption is unnecessary will be described.

The control device 2 sets low level to the power save signal S2 in the image display signal S1. The image data in the image display signal S1 goes through the gradation control circuit 111 and then is inputted to the signal line driving circuit 14 as the image data D in FIG. 3. The data resistor 142 takes the image data D by the shift pulse from the shift resistor 141 if a signal STH in the drive control signal S3 changes. The latch circuit 143 reads the image data from the data resistor 142 when a signal STB in the drive control signal S3 changes.

Level of a polarity inversion signal POL in the drive control signal S3 is different in case polarity of a pixel electrode should be positive and in case the polarity should be negative. The latch circuit 143 makes sign(+ or −) of each value in the image data D read from the data resistor 142 correspond to the level of a polarity inversion signal POL. The level shifter 144 equally raises amplitude of signals in the image data D. The digital-analog conversion circuit 145 converts digital signals in the image data D to analog signals. At the time, if a sign of a value presented by a digital signal is plus, the digital-analog conversion circuit 145 selects a voltage corresponding to the value from the voltages +V0, . . . +V63 in FIG. 4 and outputs the selected voltage. If the sign is minus, the digital-analog conversion circuit 145 selects a voltage corresponding to the value from the voltages −V0, . . . −V63 and outputs the selected voltage. The output amplifier 146 in FIG. 3 amplifies the voltage outputted from the digital-analog conversion circuit 145. The output amplifier 146 outputs image signals SX1, . . . SXn obtained by such amplifying to the signal lines.

The scanning line driving circuit 15 scans the scanning lines to turn on the pixel transistors. The image signals are impressed to the pixel electrodes through the signal lines and the pixel transistors turned on. Thus, transmittance of light in the liquid crystal layer corresponds to the image data.

Besides, the backlight control circuit 17 controls brightness of the backlight 16. As a result, light from the backlight 16 goes through the liquid crystal layer and an image is displayed in the display unit 13.

At this time, a voltage between the voltage +V63 and the voltage −V63 in FIG. 4 is impressed to the opposing electrode.

On the other hand, the voltage impressed to pixel electrodes is as follows.

For example, in case a value of 6 bits for setting brightness to the corresponding pixel is “111111”(L63) and polarity of the corresponding pixel electrode should be positive, the voltage +V63 is impressed to the pixel electrode. In case the value is the same and the polarity should be negative, the voltage −V63 is impressed to the pixel electrode. Note that “” encloses a binary number and the following figure to L is a decimal number corresponding to the binary number.

In case the value of 6 bits is “000000”(L0) and polarity of the pixel electrode should be positive, the voltage +V0 is impressed to the pixel electrode. In case the value is the same and the polarity should be negative, the voltage −V0 is impressed to the pixel electrode.

Therefore, voltage difference between the opposing electrode and the pixel electrode becomes minimum in case the value of 6 bits is “111111”(L63) while the voltage difference becomes maximum in case the value of 6 bits is “000000”(L0).

The voltage difference is used to charge a liquid crystal capacitance and a supplemental capacitance both configured with the pixel electrode. Therefore, when polarity of the pixel electrode reverses, there happens charge and discharge in the liquid crystal and the supplemental capacitance.

Therefore, electric power consumption due to the charge and discharge becomes minimum in case the value of 6 bits is “111111”(L63) while the electric power consumption becomes maximum in case the value of 6 bits is “000000”(L0).

In addition, the voltage difference between the opposing electrode and the pixel electrode is a voltage impressed to liquid crystal and the voltage impressed to liquid crystal becomes minimum in case the value of 6 bits is “111111”(L63) while the voltage becomes maximum in case the value of 6 bits is “000000”(L0).

Since the liquid crystal display device 1 is a “normally white” device, the corresponding pixel becomes brightest in case the voltage impressed to liquid crystal is minimum while the pixel becomes darkest in case the voltage is maximum.

Next, an operation in case lowering electric power consumption is necessary will be described.

The control device 2 sets high level to the power save signal S2 in the image display signal S1.

In case the level of the power save signal S2 is high, for each value of 6 bits of the image data in the image display signal S1, the gradation shift circuit 1111 bit-shifts the 6 bits to lower direction by 2 bits and thereafter set the bit value “1” to each bit of upper 2 bits of the 8 bits obtained when the bit-shifting is done. Thus, the gradation shift circuit 1111 generates a value of 8 bits for each value of 6 bits.

Next, frame rate control that changes or keeps brightness of each pixel in 4 frames is performed.

Specifically, in case lower 2 bits of the 8 bits is “11”, the frame rate control circuit 1112 keeps the brightness correspond to upper 6 bits from a 1st frame through a 4th frame.

In the case, an image data that consists of values each originally having being the corresponding value of the image data in the image display signal S1 and now being upper 6 bits of the corresponding 8 bits is inputted as the image data D in FIG. 3 to the signal line driving circuit 14. Hereinafter, an operation is performed by the same principle as the principle of the case where lowering electric power consumption is unnecessary.

On the other hand, in case lower 2 bits of the 8 bits is not “11”, the frame rate control circuit 1112 reduces 1 from upper 6 bits of the 8 bits and thereafter makes a rate correspond to lower 2 bits of the 8 bits obtained when the setting of the bit value “1” is done, the rate being a rate of a number of frame(s) when the brightness corresponds to upper 6 bits of the 8 bits obtained when the reduction is done and a number of frame(s) when the brightness corresponds to upper 6 bits of the 8 bits obtained when the setting of the bit value “1” is done.

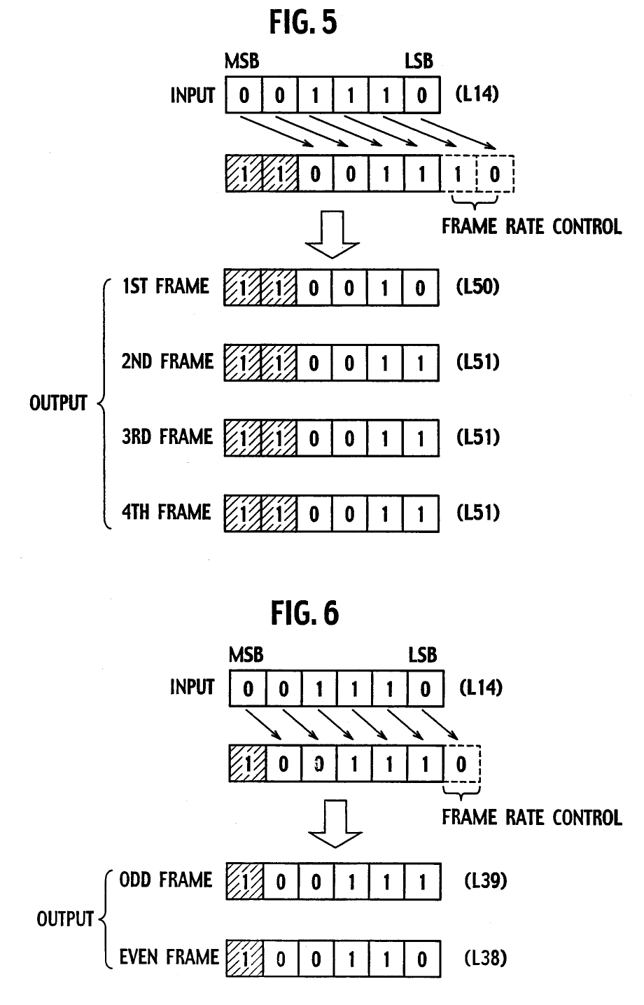

As illustrated in FIG. 5, in case a value of 6 bits of the image data in the image display signal S1 is “001110”(L14), 8 bits obtained by the bit-shifting to lower direction by 2 bits(2 bit-shifting) and the setting of the bit value “1” is “110010”.

In the case, in the 1st frame, a value is inputted to the signal line driving circuit 14, the value having originally been “001110” and now being “110010”(L50) obtained when the reduction of 1 from “110011”(L51). Hereafter, an operation is performed by the same principle as the principle of the case where lowering electric power consumption is unnecessary. Thus, brightness of the corresponding pixel corresponds to “110010”(L50).

In the 2nd frame, the brightness corresponds to “110011”(L51) which is obtained from the original value. In the 3rd and 4th frame, the brightness corresponds to “110011”(L51) as well.

Note that, since the brightness corresponding to L50 only needs to be obtained in one of the 4 frames, the brightness may be obtained in one of the 2nd, 3rd and 4th frames.

Although not illustrated, in case lower 2 bits of the 8 bits is “00”, in case the original value is “001100”(L12) for example, 8 bits obtained when the setting of the bit value “1” is done is “11001100”.

In the case, in the 1st frame, the brightness corresponds to “110011”(L51) which is obtained from the original value. In the 2nd and 3rd frame, the brightness corresponds to “110011”(L51) as well. In the 4th frame, the brightness corresponds to “110010” (L50).

Note that, since the brightness corresponding to L50 only needs to be obtained in one of the 4 frames, the brightness may be obtained in one of the 1st, 2nd and 3rd frames.

Although not illustrated, in case lower 2 bits of the 8 bits is “01”, for example, in case the original value is “001101”(L13), 8 bits obtained when the setting of the bit value “1” are done is “11001101”.

In the case, in the 1st frame, the brightness corresponds to “110011”(L51) which is obtained from the original value. In the 2nd frame, the brightness corresponds to “110010”(L50). In the 3rd frame, the brightness corresponds to “110011”(L51). In the 4th frame, the brightness corresponds to “110010”(L50).

Note that, since the brightness corresponding to L50 only needs to be obtained in two of the 4 frames, the brightness may be obtained in the 1st and 3rd frames. The brightness may be obtained in the 1st and 2nd frames. The brightness may be obtained in the 3rd and 4th frames. The brightness may be obtained in the 2nd and 3rd frames. The brightness may be obtained in the 1st and 4th frames.

As described above, intermediate grades between “110011”(L51) and “110010”(L50) can be obtained. Since the upper 2 bits “11” are invariable, a number of grades the pixel can present in one frame is only 16. However, a number of grades the pixel can present in the total frames is 64.

Note that an amount of the bit-shifting may not be 2 bits. As illustrated in FIG. 6, in case a value of 6 bits of the image data in the image display signal S1 is “001110”(L14), 7 bits obtained by the bit-shifting to lower direction by 1 bit(1 bit-shifting) and the setting of the bit value “1” is “1001110”.

And, frame rate control that changes or keeps brightness of each pixel both in an even number frame and in an odd number frame is performed.

Specifically, in case a lower 1 bit (LSB) of the 7 bits is “0”, the frame rate control circuit 1112 keeps the brightness correspond to upper 6 bits “100111”(L39) both in the even number frame and in the odd number frame.

On the other hand, in case a lower 1 bit (LSB) of the 7 bits is “1”, the frame rate control circuit 1112 reduces 1 from upper 6 bits of the 7 bits to have the 6 bits become “100110”(L38). The frame rate control circuit 1112 thereafter makes the brightness corresponds to 6 bits “100111”(L39) that are 6 bits of the 7 bits obtained when the setting of the bit value “1” is done in the odd number frame while the frame rate control circuit 1112 makes the brightness corresponds to the 6 bits “100110”(L38) in the even number frame for example. The frame rate control circuit 1112 may reverse this in the odd number frame and the even number frame.

As described above, intermediate grades between “100111”(L39) and “100110”(L38) can be obtained. Since the upper 1 bit “1” (MSB) is invariable, a number of grades the pixel can present in one frame is only 32. However, a number of grades the pixel can present in the total frames is 64.

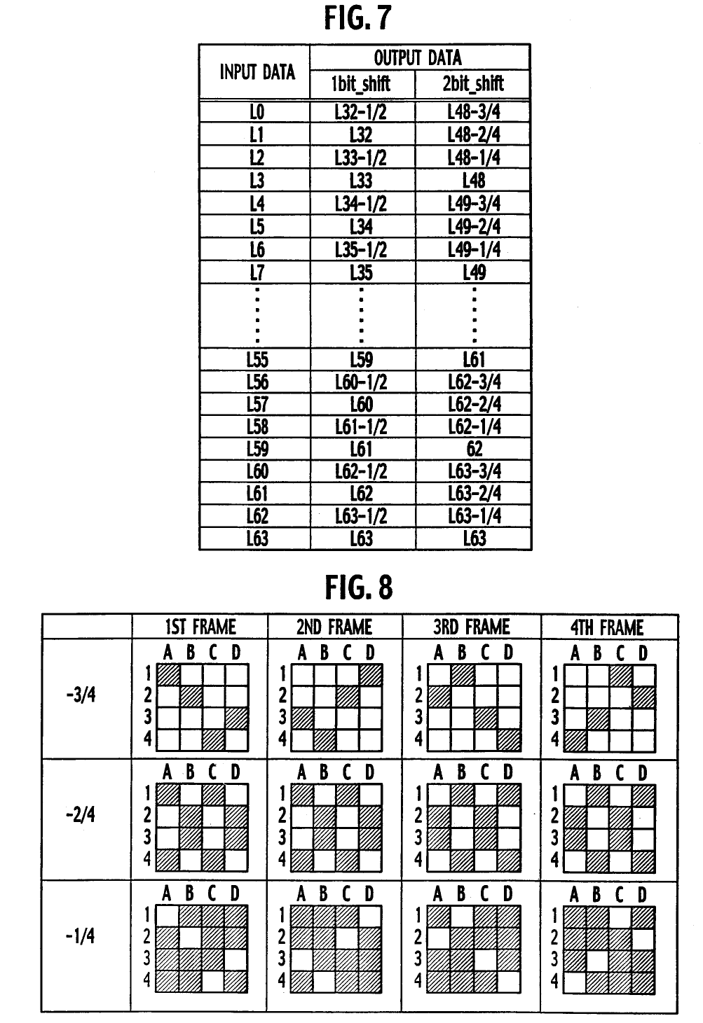

In FIG. 7, the original values prepared for setting brightness to a pixel are designated in input data columns. In output data columns, the methods of setting the brightness are designated separately in the case of 1 bit-shifting and the case of 2 bit-shifting. Values being used for keeping the brightness in frames are designated in the output data columns like L48 of the 2 bit-shifting. Rates are designated like -3/4 in the output data columns, the each rate being a rate of a number of frame(s) when the brightness corresponds to upper 6 bits of the 7 or 8 bits obtained when the reduction is done and a number of frame(s) when the brightness corresponds to upper 6 bits of the 7 or 8 bits obtained when the setting of the bit value “1” is done. The each rate is designated together with the corresponding value used for making the brightness corresponds to the upper 6 bits of the 7 or 8 bits obtained when the setting of the bit value “1” is done.

In case of L62-3/4 in FIG. 7, in the 1st frame, brightness of pixels A1, B2, C4 and D3 illustrated darkly in FIG. 8 is made correspond to L62 while brightness of other pixels are made correspond to L61. In the 2nd frame, brightness of pixels A3, B4, C2 and D1 is made correspond to L62 while brightness of other pixels is made correspond to L61. In the 3rd frame, brightness of pixels A2, B1, C3 and D4 is made correspond to L62 while brightness of other pixels is made correspond to L61. In the 4th frame, brightness of pixels A4, B3, C1 and D2 is made correspond to L62 while brightness of other pixels is made correspond to L61.

In short, in case of including -1/4, -2/4, or -3/4 in FIG. 7, brightness of pixels illustrated darkly in a corresponding column of FIG. 8 is made correspond to upper 6 bits of the bits obtained when the setting of the bit value “1” is done while brightness of other pixels is made correspond to upper 6 bits of the bits obtained when the reduction is done.

Flicker might happen in case control in FIG. 8 is not done, for example, in the 1st, 2nd and 3rd frames, brightness of all pixels is made correspond to upper 6 bits of the bits obtained when the setting of the bit value “1” is done while in the 4th frame brightness of all pixels is made correspond to upper 6 bits of the bits obtained when the reduction is done.

However, by doing the control in FIG. 8, specifically by making distribution of the pixels different each other, the each distribution being distribution of frame(s) in which brightness of the corresponding pixel is made correspond to upper 6 bits of the bits obtained when the setting of the bit value “1” is done and frame(s) in which brightness of the corresponding pixel is made correspond to upper 6 bits of the bits obtained when the reduction is done, flicker can be prevented from happening.

The backlight control circuit 17 lowers the brightness of the backlight 16 when the power save signal S2's level is high.

Since the upper 1 bit “1” or upper 2 bits “11” is invariable, if the brightness of the backlight 16 is not lowered, color corresponding to intermediate grades between grades of black and white is biased to white. Therefore an image is displayed like white. In other words, the pixels become brighter.

However the image can be prevented from being displayed like white by lowering the brightness of the backlight 16. In other words, the pixels are prevented from being brighter. In addition, electric power consumption in the backlight 16 lowers by lowering the brightness of the backlight 16.

In addition, since the upper 1 bit “1” or upper 2 bits “11” is invariable, a difference of voltage is low, the difference being difference of voltage when the liquid crystal capacitance and the charged supplemental capacitance are charged and voltage when the liquid crystal capacitance and the charged supplemental capacitance are discharged. Therefore, electric power consumption due to charge and discharge in the liquid crystal capacitance and the supplemental capacitance can be lowered. In addition, since lowering frequency of driving the scanning lines (driving frequency) is not done, flicker can be prevented from happening.

Although the electric power consumption due to charge and discharge is made to be minimum in case the original value is “111111”(L63), the electric power consumption may be made minimum in case the original value is “000000”(L0). In the case, a bit value “0” is set to each of upper bits of the bits obtained when the bit-shifting is done.

In addition, in case of 2 bit-shifting, the gradation shift circuit 1111 may be configured to make a rate correspond to lower 2 bits of the 8 bits obtained when the setting of the bit value “0” is done, the rate being a rate of a number of frame(s) when the corresponding brightness corresponds to upper 6 bits of the 8 bits obtained when the reduction is done and a number of frame(s) when the brightness corresponds to upper 6 bits of the 8 bits obtained when the setting of the bit value “0” is done.

In case of 1 bit-shifting, the gradation shift circuit 1111 may be configured to make a rate correspond to a lower 1 bit of the 8 bits obtained when the setting of the bit value “0” is done, the rate being a rate of a number of frame(s) when the corresponding brightness corresponds to upper 6 bits of the 7 bits obtained when the reduction is done and a number of frame(s) when the brightness corresponds to upper 6 bits of the 7 bits obtained when the setting of lo the bit value “0” is done.

In case of 2 bit-shifting, the number of grades the pixel can present in one frame is 16 but the gradation shift circuit 1111 makes a number of grades in the total frames be 64. Note that the gradation shift circuit 1111 may be configured to make a number of grades in the total frames be 32.

Although an amount of the bit-shifting is 1 bit or 2 bits, the amount of the bit-shifting may be different.

Although the gradation shift circuit 1111 reduces 1 from upper 6 bits of the bits obtained when the setting of the bit value is done, the gradation shift circuit 1111 may be configured to add 1 to the upper 6 bits and thereafter makes a rate correspond to lower bit(s) of the bits obtained when the setting of the bit value is done, the rate being a rate of a number of frame(s) when the brightness corresponds to upper 6 bits of the bits obtained when the addition is done and a number of frame(s) when the brightness corresponds to upper 6 bits of the bits obtained when the setting of the bit value is done.

So far, a case that the original value consists of 6 bit is described. Since a value capable of presenting 256 grades consists of 8 bits, the value of 8 bits may be used.

The control of the rate is done so as to compensate decrease in a number of grades the pixel can present due to the bit-shifting and the setting of the bit value by realizing psuedo gradation. Therefore, the control of the rate may not be done if the compensation is unnecessary.

Although the liquid crystal display device is a “normally white” device, the liquid crystal display device may be a “normally black” device.

As described above, each pixel consumes minimum electric power if a bit value “k”(k:1 mainly in the embodiment) is set to each bit of n(n:6 mainly in the embodiment) bits used for setting brightness to the pixel. The liquid crystal display device 1 has the gradation shift circuit 1111 configured to bit-shift the n bits to lower direction by m(m: 1 or 2 mainly in the embodiment) bit(s) and thereafter set the bit value “k” to each bit of upper m bit(s) of the bits obtained when the bit-shifting is done. The liquid crystal display device 1 has, as a circuit to make the brightness corresponds to upper n bit(s) of the bits obtained when the setting of the bit value “k” is done, the timing control circuit 112, the signal line driving circuit 14, the scanning line driving circuit 15 and the like. Since each of the upper m bit(s) set by the bit value “k” is invariable, electric power consumption due to the charge and discharge in pixels can be lowered, flicker due to lowering driving frequency not happening.

The liquid crystal display device 1 has the frame rate control circuit 1112 configured to add or reduce 1 to or from upper n bits of the bits obtained when the setting of the bit value “k” is done and thereafter make a rate correspond to lower m bit(s) of the bits obtained when the setting of the bit value “k” is done, the rate being a rate of a number of frame(s) when the brightness corresponds to upper n bits of the bits obtained when the addition or the reduction is done and a number of frame(s) when the brightness corresponds to upper n bits of the bits obtained when the setting of the bit value “k” is done. Therefore, a number of grades the pixel can present in one frame lowers, but a number of grades the pixel can present in the total frames can be more than the number of grades in one frame.

In case the liquid crystal display device 1 is a “normally white” device, the pixels become brighter if the brightness of the backlight 16 is not lowered, due to the bit-shifting and the setting of the bit value “k”. However the liquid crystal display device 1 has the backlight control circuit 17 to lower the brightness the backlight 16 in case the bit-shifting and the setting of the bit value “k” are done. Therefore, electric power consumption in the backlight 16 lowers. It contributes to lowering electric power consumption in the device together with lowering electric power consumption in the pixels.

What is claimed is:

1. A liquid crystal display device having pixels each consuming minimum electric power if a bit value “k”(k:1 or 0) is set to each bit of n(n: integer equal to or more than 2) bits used for setting brightness to the pixel, the liquid crystal display device comprising:
a gradation shift circuit configured to bit-shift the n bits to lower direction by m(m: integer) bit(s) and thereafter set the bit value “k” to each bit of upper m bit(s) of the bits obtained when the bit-shifting is done, and
a circuit configured to make the brightness corresponds to upper n bit(s) of the bits obtained when the setting of the bit value “k” is done.

2. A liquid crystal display device having pixels each consuming minimum electric power if a bit value “k”(k:1 or 0) is set to each of n(n: integer equal to or more than 2) bits used for setting brightness to the pixel, the liquid crystal display device comprising:
a gradation shift circuit configured to bit-shift the n bits to lower direction by m(m: integer) bit(s) and thereafter set the bit value “k” to each of upper m bit(s) of the bits obtained when the bit-shifting is done, and
a frame rate control circuit configured to add or reduce 1 to or from upper n bits of the bits obtained when the setting of the bit value “k” is done and thereafter make a rate correspond to lower m bit(s) of the bits obtained when the setting of the bit value “k” is done, the rate being a rate of a number of frame(s) when the brightness corresponds to upper n bits of the bits obtained when the addition or the reduction is done and a number of frame(s) when the brightness corresponds to upper n bits of the bits obtained when the setting of the bit value “k” is done.

3. A liquid crystal display device according claim 1 or claim 2, further comprising:
a backlight facing a back side of the pixels, and
a backlight control circuit configured to lower brightness of the backlight in case the bit-shifting and the setting of the bit value “k” are done to prevent the pixel from being brighter.
